(19) United States
(12) Patent Application Publication
(10) Pub. No.: US 2026/0070341 A1
(43) Pub. Date: Mar. 12, 2026

(54) CLEANING UNIT AND CLEANING METHOD

(71) Applicant: KYOCERA DOCUMENT SOLUTIONS INC., OSAKA (JP)

(72) Inventor: MOTONOBU SUGIMOTO, OSAKA (JP)

(21) Appl. No.: 19/324,137

(22) Filed: Sep. 10, 2025

(30) Foreign Application Priority Data
Sep. 11, 2024 (JP) 2024-157615

(51) Int. Cl. B41J 2/165; C11D 7/50

(52) U.S. Cl. CPC B41J 2/16552; C11D 7/5022; B41J 2002/16558; C11D 2111/14

(57) ABSTRACT

A cleaning unit for cleaning a nozzle surface of an inkjet printhead, includes a flexible porous material; and a cleaning liquid impregnated in the flexible porous material and having viscosity at 25° C. of 7 mPa·s or less and static surface tension at 25° C. of 40 mN/m or less, and containing from 10 mass % or more to 60 mass % or less of a water-soluble organic solvent, in which a vapor pressure of the water-soluble organic solvent at 25° C. is lower than that of water.

### CROSS-REFERENCE TO RELATED PATENT APPLICATION

This application claims the benefit of Japanese Priority Patent Application JP 2024-157615 filed Sep. 11, 2024, under 35 U.S.C. 119, the entire contents of which are incorporated herein by reference.

### FIELD OF THE DISCLOSURE

The present disclosure relates to a cleaning unit and a cleaning method for cleaning a nozzle surface of an inkjet head.

### BACKGROUND OF THE DISCLOSURE

Inkjet recording apparatuses use ink that is highly dry and contains a binder resin for printing on non-absorbent media that do not absorb ink, such as coated paper and a resin sheet. When such ink is attached and dried on a nozzle surface on which nozzles are arranged in an inkjet head, it adheres strongly to the nozzle surface. An ink dry matter that has adhered strongly to the nozzle surface is difficult to be removed with a normal cleaning operation.

Japanese Patent Application Laid-open No. 2006-272097 discloses a technology for removing any ink dry matter adhered to the nozzle surface of the inkjet head. In the technology described in Japanese Patent Application Laid-open No. 2006-272097, the nozzle surface is immersed in a cleaning liquid in a cleaning liquid tank, and a wiping member is vibrated while the nozzle surface is pressed against the wiping member provided on a bottom surface of the cleaning liquid tank. The ink dry matter adhered to the nozzle surface is thereby removed by dissolution into the cleaning liquid and an impact applied by the wiping member.

### SUMMARY OF THE DISCLOSURE

In order to achieve the above-mentioned object, a cleaning unit according to one embodiment of the present disclosure is used to clean a nozzle surface of an inkjet head.

The cleaning unit includes a flexible porous material and a cleaning liquid impregnated in the flexible porous material.

The cleaning liquid has viscosity at 25° C. of 7 mPa's or less and static surface tension at 25° C. of 40 mN/m or less, and contains 10 mass % or more and 60 mass % or less of a water-soluble organic solvent, in which a vapor pressure at 25° C. of the water-soluble organic solvent is lower than water.

### BRIEF DESCRIPTION OF THE DRAWINGS

FIG. 1 is a flowchart of a cleaning method according to one embodiment of the present disclosure.

FIG. 2 is a diagram showing Step S01 (immersion step) of the above cleaning method.

FIG. 3 is a diagram showing Step S01 (immersion step) of the cleaning method.

FIG. 4 is a diagram showing Step S02 (wiping step) of the above cleaning method.

### DETAILED DESCRIPTION OF THE EXEMPLARY EMBODIMENTS

In order to remove an ink dry matter that has strongly adhered from the nozzle surface, a time for immersing the nozzle surface in the cleaning liquid, which is about 10 seconds as described in Japanese Patent Application Laid-open No. 2006-272097, may be insufficient. On the other hand, since evaporation of the cleaning liquid progresses over time, it is necessary to increase the amount of cleaning liquid in a cleaning liquid tank in order to increase the time for immersing the nozzle surface in the cleaning liquid. This increases the amount of cleaning liquid consumed in order to clean the nozzle surface.

In view of the above circumstances, an object of the present disclosure is to provide a cleaning unit that can achieve a high cleaning effect while reducing the amount of the cleaning liquid consumed.

Embodiments of the present disclosure will be described.

### [Overall Configuration of Cleaning Unit U]

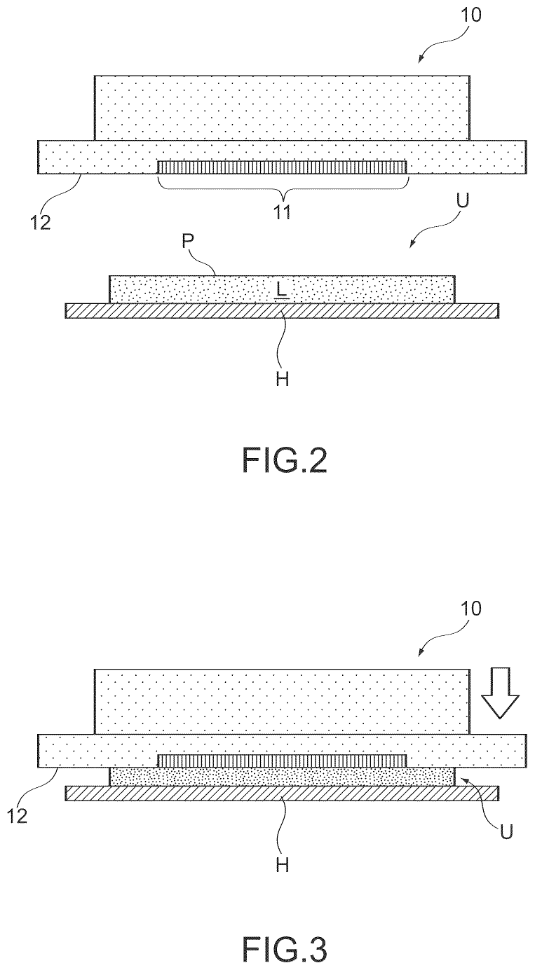

A cleaning unit U (see FIGS. 2 and 3) according to one embodiment of the present disclosure is a complex unit for cleaning the nozzle surface on which nozzles are arranged in an inkjet head (hereinafter simply referred to as “head”) mounted on an inkjet recording apparatus. The cleaning unit U may be mounted on the inkjet recording apparatus or may configure an independent cleaning apparatus separated from the inkjet recording apparatus.

The cleaning unit U is configured to be able to remove the ink dry matter strongly adhered to the nozzle surface of the head, which is difficult to be removed by a cleaning mechanism installed in a general inkjet recording apparatus. The ink that tends to strongly adhere to the nozzle surface of the head includes, for example, an ink that is highly dry and contains a binder resin, which is used for printing on non-absorbent media that do not absorb ink, such as coated paper and a resin sheet.

The cleaning unit U has a flexible porous material P and a cleaning liquid L impregnated in the flexible porous material P. The flexible porous material P is a flexible porous structure, typically configured of a fabric, which is a collection of fibers. The cleaning liquid L impregnates the flexible porous material P by entering into numerous pores of the flexible porous material P. In other words, in the cleaning unit U, the cleaning liquid L is contained within the numerous pores of the flexible porous material P.

In the cleaning unit U, when the flexible porous material P is subjected to pressure, the total volume of the numerous pores of the flexible porous material P shrinks due to compressive deformation, and some of the cleaning liquid L impregnated in the flexible porous material P seeps out from the surface of the flexible porous material P. In the cleaning unit U, when the pressure on the flexible porous material P is released, the flexible porous material P returns to its original shape, and the cleaning liquid L that has seeped out returns to the numerous pores of the flexible porous material P.

The cleaning liquid L in the cleaning unit U is configured to have a good penetration action to be soaked into a gap between the ink dry matter adhered to the nozzle surface and the nozzle surface. The cleaning liquid L can progressively peel off the ink dry matter from the nozzle surface by the penetration action. In order to obtain the good penetration action, the cleaning liquid L advantageously needs to have certain low viscosity and has low static surface tension.

Specifically, in order to obtain the good penetration action, the cleaning liquid L has the viscosity at 25° C. of 7 mPa·s or less, preferably 4 mPa's or less, and more preferably 2 mPa's or less. The viscosity of the cleaning liquid L at 25° C. is measured with an E-type viscometer (TV-100EL, Toki Sangyo Co., Ltd.).

In order to obtain the good penetration action, the cleaning liquid L has the static surface tension at 25° C. of preferably 40 mN/m or less, more preferably 35 mN/m or less, and even more preferably 25 mN/m or less. The static surface tension at 25° C. of the cleaning liquid L is measured according to the Wilhelmy method (plate method), using a surface tension measuring meter (“Automatic Surface Tension Tester DY-300” manufactured by Kyowa Surface Science Co., Ltd.)

In the cleaning liquid L, the viscosity and the static surface tension can be adjusted depending on constituents. Specifically, the cleaning liquid L contains 10 mass % or more of a water-soluble organic solvent. In the cleaning liquid L, the viscosity can be adjusted by a type and an amount of the water-soluble organic solvent. In addition, a surfactant can be added to the cleaning liquid L, if necessary. In the cleaning liquid L, the static surface tension can be adjusted by a type and an amount of the surfactant.

In addition to the penetration action of the cleaning liquid L described above, the cleaning unit U is configured to obtain an evaporation suppression action that suppresses evaporation of the cleaning liquid L. Specifically, in the cleaning liquid L, the water-soluble organic solvent is selected in terms of volatility as well as the viscosity and the static surface tension. In other words, in the cleaning unit U, a water-soluble organic solvent with a low vapor pressure is used as a component of the cleaning liquid L so that the volatility of the cleaning liquid L is low.

In the cleaning liquid L, a water-soluble organic solvent with a vapor pressure at 25° C. lower than that of water (2.9 kPa) is used to keep the volatility at least equal to or lower than that of water. In the cleaning liquid L, the vapor pressure of the water-soluble organic solvent at 25° C. is preferably 2.5 kPa or less, more preferably 1.0×10⁻¹ kPa or less, and even more preferably 2.0×10⁻² kPa or less in order to further reduce the volatility.

In the cleaning unit U, by impregnating the flexible porous material P with the cleaning liquid L, evaporation of the cleaning liquid L can be further suppressed. In other words, in the cleaning unit U, evaporation of the cleaning liquid L proceeds by evaporation of the cleaning liquid L on the surface of the flexible porous material P and diffusion of the cleaning liquid L from inside of the flexible porous material P to the surface, but a supply of the cleaning liquid L with a slow diffusion speed to the surface of the flexible porous material P is delayed, so the evaporation of the cleaning liquid L is suppressed.

Thus, in the cleaning unit U, a synergistic effect of reducing the volatility of the cleaning liquid L and impregnating the flexible porous material P with the cleaning liquid L can significantly suppress a decrease of the cleaning liquid L due to evaporation over time. This allows the cleaning unit U to continue to apply a small amount of the cleaning liquid L to the nozzle surface with the ink dry matter adhered over a long period of time, thereby reducing the amount of the cleaning liquid L consumed.

### [Cleaning Method]

### INTRODUCTION

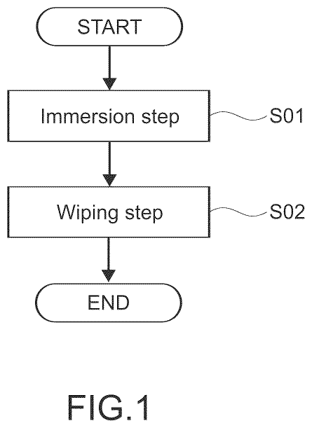

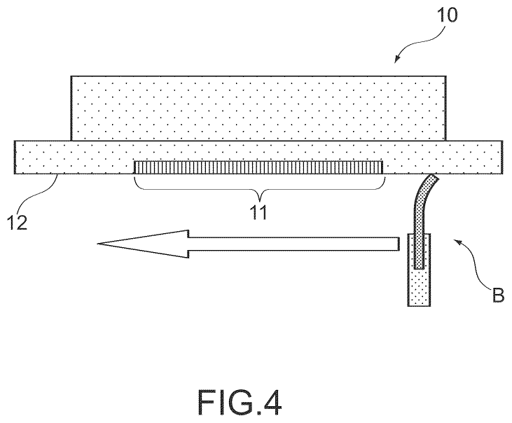

In a cleaning method according to an embodiment of the present disclosure, the nozzle surface of the head is cleaned using the cleaning unit U described above. FIG. 1 is a flowchart showing the cleaning method according to this embodiment. The cleaning method according to this embodiment includes Step S01 (immersion step) and Step S02 (wiping step). FIGS. 2 and 3 show Step S01 (immersion step), and FIG. 4 shows Step S02 (wiping step).

(Step S01: immersion step)

In Step S01, a nozzle surface 12 on which nozzles 11 are arranged in a head 10 is immersed in the cleaning liquid L in the cleaning unit U. Specifically, first, as shown in FIG. 2, the nozzle surface 12 of the head 10 is faced from above to the cleaning unit U held by a holding member H. Then, as shown in FIG. 3, the nozzle surface 12 of the head 10 pushes the flexible porous material P of the cleaning unit U to compress and deform the flexible porous material P.

The nozzle surface 12 of the head 10 shown in FIG. 3 is coated by the cleaning liquid L that seeps out from the numerous pores of the flexible porous material P as the flexible porous material P is compressed and deformed, and is immersed in the cleaning liquid L. In other words, the nozzle surface 12 in an immersed state shown in FIG. 3 is in substantially the same state as the nozzle surface submerged in the cleaning liquid L filled in the cleaning liquid tank without being impregnated with the flexible porous material P.

At the nozzle surface 12 of the head 10, by holding the nozzle surface 12 in the immersed state for a predetermined time, swelling of the ink dry matter by an action of the cleaning liquid L and penetration of the cleaning liquid L into the ink dry matter progress over time, causing the ink dry matter to peel off or adherence strength of the ink dry matter to decrease. As a result, in Step S01, the ink dry matter adhered to the nozzle surface 12 will be easily removed from the nozzle surface 12.

In the nozzle surface 12 to which the ink dry matter is strongly adhered, which is assumed in this embodiment, a holding time in the immersed state needs to be extended to some extent in order to remove the ink dry matter. The holding time of the nozzle surface 12 in the immersed state is preferably 30 minutes or more, and more preferably 1 hour or more. In order to reduce the amount of the cleaning liquid L consumed, the holding time in the immersed state of the nozzle surface 12 is preferably 2 hours or less.

### (Step S02: Wiping Step)

In Step S02, the nozzle surface 12 after Step S01 is wiped to remove the ink dry matter. In Step S02, a blade B is used as a wiping component to wipe the nozzle surface 12. The blade B is configured as a plate-shaped member whose tip extends parallel to the nozzle surface 12 and is wider than an area where the nozzles 11 are arranged. The blade B is formed of a flexible and sliding material, for example, sliding rubber.

Specifically, in Step S02, as shown in FIG. 4, the blade B is slid along the nozzle surface 12 with the tip of the blade B in contact with the nozzle surface 12. As a result, the ink dry matter that has peeled off from the nozzle surface 12 is removed by moving with the blade B. The ink dry matter adhering to the nozzle surface 12 with weak force is scraped off by the tip of the blade B in the process of sliding of the blade B.

In Step S02, if the ink dry matter adhered to the nozzle surface 12 in Step S01 can be sufficiently peeled off, wiping may be performed by the wiping member other than the blade B, such as a nonwoven fabric, for example. The blade B and the wiping member such as the nonwoven fabric used in Step S02 may be provided in the inkjet recording apparatus or in the cleaning unit U, or may configure an independent wiping apparatus.

### [Detailed Configuration of Cleaning Unit U]

### (Flexible Porous Material P)

The flexible porous material P is not limited to a specific configuration and can be, for example, a nonwoven or woven fabric made of a fiber material or a sponge made of synthetic resin foam. The fiber material configuring the nonwoven or woven fabric can be selected from, for example, a natural cellulose fiber, a recycled cellulose fiber, and a synthetic fiber, among which pulp, cotton, rayon, polyacrylate, etc. with high water absorbency are preferable.

### (Cleaning Liquid L)

The water-soluble organic solvent that can be used for the cleaning liquid L include, for example, 1,2-propanediol (1.1×10⁻² kPa), 1,3-propanediol (1.2×10⁻³ kPa), glycerin (3.1×10⁻⁶ kPa), 2-pyrrolidone (1.1×10⁻³ kPa), diethylene glycol monoethyl ether (1.3×10⁻² kPa), 2-[2-(2-butoxyethoxy) ethoxy]ethanol (2.7×10 5 kPa), and the like (numerical values in parentheses indicate vapor pressure at 25° C.).

In the cleaning liquid L, a combination of multiple water-soluble organic solvents may be used, in which case the content of the water-soluble organic solvent indicates the sum of the content of all water-soluble organic solvents, and the vapor pressure of the water-soluble organic solvent indicates the vapor pressure of the water-soluble organic solvent with the highest vapor pressure. In other words, for example, the cleaning liquid L with the vapor pressure at 25° C. of 2.5 kPa or less of the water-soluble organic solvent does not contain any water-soluble organic solvent with the vapor pressure at 25° C. exceeding 2.5 kPa.

As the surfactant in the cleaning liquid L, a nonionic surfactant is preferably used, among which an acetylene-based surfactant is preferably used. Commercial products of the acetylene-based surfactant include, for example, Olfine (registered trademark) E1010, Olfine (registered trademark) EXP.4200, Olfine (registered trademark) EXP.4300, Surfinol (registered trademark) 420, and Surfinol (registered trademark) 440 manufactured by Nissin Chemical Industry Co., Ltd.

If necessary, the cleaning liquid L may contain known additives to obtain the above functions more effectively or to obtain functions different from the above functions. The known additives include, for example, a dissolution stabilizer, an anti-drying agent, an antioxidant, a viscosity adjuster, a pH adjuster, an anti-fungal agent, etc. The cleaning liquid L contains water as the rest of the above components. In the cleaning liquid L, ion-exchanged water, purified water, distilled water, etc. can be used as water, for example.

In the cleaning liquid L, the content of the water-soluble organic solvent may be 10 mass % or more, but it is easy to obtain good performance by keeping the content 60 mass % or less. In the cleaning liquid L, it is easy to obtain good performance by keeping the content of the surfactant within the range from 0.1 mass % or more to 5 mass % or less. Furthermore, in the cleaning liquid L, it is easy to obtain good performance by setting the content of water within the range from 50 mass % or more to 90 mass % or less.

### OTHER EMBODIMENTS

Although the embodiments of the present disclosure are described above, the present disclosure is not limited only to the embodiments described above, and various changes can be made. For example, the cleaning unit U according to the present disclosure may have a configuration other than the flexible porous material P and the cleaning liquid L, if necessary. The cleaning method according to the present disclosure may also include steps other than Step S01 (immersion step) and Step S02 (wiping step).

### Examples and Comparative Examples

Examples of the present disclosure are described below, but the present disclosure is not limited to these examples.

### (General Description)

In each of Examples 1 to 6 and Comparative Examples 1 and 2, the cleaning unit was fabricated using cleaning liquids of mutually different compositions. In each of the Examples and Comparative Examples, a woven fabric (Toraysee (registered trademark) PW (Toray Industries, Inc.)) was used commonly as the flexible porous material. In each of the Examples and Comparative Examples, removal performance of the cleaning unit and drying suppression performance of the flexible porous material were evaluated.

### (Method of Evaluating Removal Performance of Cleaning Unit)

In each of the Examples and Comparative Examples, an adhered sample of the head with the same degree of the ink dry matter adhered to the nozzle surface was prepared, and the removal performance of the ink dry matter adhered to the nozzle surface by the cleaning unit was evaluated using the adhered sample.

The adhered sample of the head was fabricated by filling an ink tank with ink and keeping it for 72 hours at a temperature of 35° C. and humidity of 15% with the ink overflowing the nozzle surface of the head by making a 0.5 cm water head difference between the ink tank and the head. J4B-QA manufactured by Kyocera Corporation was used for the head, and Truepress ink SC+ YEL00 manufactured by SCREEN Graphic Solutions Inc. was used for the ink.

In each of the Examples and Comparative Examples, the cleaning unit was prepared by dropping 2 ml of the cleaning liquid onto a 20 cm×2.5 cm flexible porous material on a Teflon (registered trademark) impervious sheet placed on an EPDM sponge member. The nozzle surface of the sample of the head was then pressed against each cleaning unit and held for 1 hour with each cleaning unit pressed between the sponge member and the nozzle surface, thereby performing the immersion step of the cleaning method.

Then, the cleaning unit on the sponge member was replaced with a new flexible porous material, and the flexible porous material into 2 ml of the cleaning liquid was dropped as the wiping member to wipe the nozzle surface of the head sample once at a surface pressure of 0.09 N/m² and a linear velocity of 20 mm/s to perform the wiping step of the cleaning method. In each of Examples and Comparative Examples, the removal performance of the cleaning unit was evaluated by observing the nozzle surface of the adhered sample after the wiping step.

Specifically, the removal performance of the cleaning unit was evaluated by a removal rate. The removal rate (%) was determined as 100×(N₀−N₁)/N₀, where No is the number of the ink dry matter in the adhered sample before the immersion step and N₁ is the number of the ink dry matter in the adhered sample after the wiping step. In each of Examples and Comparative Examples, it is shown that the higher the removal rate is, the better the removal performance of the cleaning unit is.

### (Evaluation Method of Drying Suppression Performance of Cleaning Liquid by Flexible Porous Material)

In each of the Examples and Comparative Examples, the cleaning unit was prepared by stacking 10 sheets of the flexible porous material cut to ¢40 mm in a ¢40 mm petri dish and impregnating them with approximately 4 g of the cleaning liquid. An initial mass M₀ of the cleaning liquid was measured for each cleaning unit, and then the unit was allowed to stand for 4 hours at a temperature of 35° C. and humidity of 15%. A dry mass M₁ of the cleaning liquid after standing was measured, and a drying rate R₁ (%) was determined by (1−(M₁/M₀))×100. The initial mass M₀ and the dry mass M₁ were measured in the same manner without using the flexible porous material, and a drying rate R₂ (%) was determined in the same manner. Then, the drying suppression rate (%) was determined for each of Examples and Comparative Examples by (1−(R₁/R₂))×100. In each of the Examples and Comparative Examples, it is shown that the higher the drying suppression rate is, the better the performance of the flexible porous material in suppressing the drying of the cleaning liquid.

### (Cleaning Liquid)

In each of Examples 1 to 6 and Comparative Examples 1 and 2, the cleaning liquid for the cleaning unit was prepared by mixing and stirring the components shown in Table 1. The numerical values shown for each component in Table 1 represent the content (mass parts) of each component. Table 1 also shows the vapor pressure at 25° C. for each water-soluble organic solvent and water. Furthermore, Table 1 shows the static surface tension and the viscosity of each cleaning liquid at 25° C.

In Examples 1 to 6, the type and the content of water-soluble organic solvents in the cleaning liquids are variously changed. In all of Examples 1 to 6, the composition of the cleaning liquid was within the range of the above embodiments, i.e., the cleaning liquid contained 10 mass % or more of the water-soluble organic solvent whose vapor pressure at 25° C. was lower than water, and the viscosity of the cleaning liquid at 25° C. was 7 mPa's or less. In addition, the static surface tension of the cleaning liquid at 25° C. was 40 mN/m or less in any of Examples 1 to 6.

In Comparative Example 1, the composition of the cleaning liquid differs from the above embodiment in that the cleaning liquid contained no water-soluble organic solvent and the static surface tension of the cleaning liquid at 25° C. exceeded 40 mN/m. In Comparative Example 2, the composition of the cleaning liquid differs from the above embodiment in that the content of the water-soluble organic solvent exceeded 60 mass % and the viscosity of the cleaning liquid at 25° C. exceeded 7 mPa·s.

### (Evaluation Results)

Table 1 shows the removal rate and the drying suppression rate as evaluation results of the cleaning units in each of Examples 1 to 6 and Comparative Examples 1 and 2. In all of Examples 1 to 6, the removal rate was 70% or higher, indicating that good removal performance was obtained in the cleaning units. In particular, in all of Examples 1 to 3, where the viscosity of the cleaning liquid at 25° C. was 1.5 or less and the vapor pressure of the water-soluble organic solvent at 25° C. was less than 1/100 of water, the removal rate was 100%, and the ink dry matter adhered to the nozzle surface of the head sample was completely removed. In addition, in all of the cleaning units according to Examples 1 to 6, the drying suppression performance of the cleaning liquid by the flexible porous material was well obtained. Furthermore, from the drying suppression rate of each cleaning unit according to Examples 1 to 6, it was observed that the higher the vapor pressure of the water-soluble organic solvent contained in the cleaning liquid is, the better a drying suppression effect by the flexible porous material was obtained.

On the other hand, in each of Comparative Examples 1 and 2, the removal rate was 0% and the ink dry matter adhered to the nozzle surface of the head sample could not be removed. It is believed to be because in Comparative Example 1, the high surface tension did not allow the penetration action of the cleaning liquid to soak between the nozzle surface and the ink dry matter to occur. It is believed to be because in Comparative Example 2, the high viscosity of the cleaning liquid did not allow the penetration action of the cleaning liquid to soak between the nozzle surface and the ink dry matter to be ineffectively achieved. In the cleaning unit according to Comparative Example 1, the drying suppression effect of the cleaning liquid by the flexible porous material was small. It is believed to be because the static surface tension of the cleaning liquid was high and affinity of the cleaning liquid to the flexible porous material was low in the cleaning unit according to Comparative Example 1. On the other hand, in the cleaning unit according to Comparative Example 2, the drying suppression effect of the cleaning liquid by the flexible porous material was great. It is believed to be because the static surface tension of the cleaning liquid was low and the affinity of the cleaning liquid to the flexible porous material was high in the cleaning unit according to Comparative Example 2.

TABLE 1

| | | Vapor | | | | | | | Comparative | |
|---|---|---|---|---|---|---|---|---|---|---|
| | | pressure | Example | | | | | | Example | |
| | | @25° C. (kPa) | 1 | 2 | 3 | 4 | 5 | 6 | 1 | 2 |
| Water- | 1,2-propanediol | 1.1 × 10⁻² | 10 | 0 | 0 | 0 | 0 | 0 | 0 | 0 |
| soluble | 1,3-propanediol | 1.2 × 10⁻³ | 0 | 10 | 0 | 0 | 0 | 0 | 0 | 60.8 |
| organic | Glycerin | 3.1 × 10⁻⁶ | 0 | 0 | 10 | 0 | 0 | 0 | 0 | 0 |
| solvent | 2-pyrrolidone | 1.1 × 10⁻³ | 0 | 0 | 0 | 9 | 0 | 0 | 0 | 0 |
| | Diethylene glycol | 1.3 × 10⁻² | 0 | 0 | 0 | 13 | 0 | 0 | 0 | 0 |
| | monoethyl ether | | | | | | | | | |
| | 2-[2-(2-butoxyethoxy) | 2.7 × 10⁻⁵ | 0 | 0 | 0 | 9 | 0 | 0 | 0 | 0 |
| | ethoxy]ethanol | | | | | | | | | |
| | Ethylene glycol | 1.4 | 0 | 0 | 0 | 0 | 10 | 0 | 0 | 0 |
| | monomethyl ether | | | | | | | | | |
| | Ethylene glycol | 1.2 × 10⁻¹ | 0 | 0 | 0 | 0 | 0 | 10 | 0 | 0 |
| | monombuthyl ether | | | | | | | | | |
| Surfactant | Olfine E1010 | — | 1 | 1 | 1 | 0 | 1 | 1 | 0 | 0 |
| | Amogen CB-H | — | 0 | 0 | 0 | 2.5 | 0 | 0 | 0 | 0 |
| | KL-870 | — | 0 | 0 | 0 | 0.4 | 0 | 0 | 0 | 0 |
| | Silface SAG503A | — | 0 | 0 | 0 | 0 | 0 | 0 | 0 | 0.3 |

| | | | | | | | | | |
|---|---|---|---|---|---|---|---|---|---|
| Water | 2.9 | 89 | 89 | 89 | 62.1 | 89 | 89 | 100 | 38.9 |

| | | | | | | | | |
|---|---|---|---|---|---|---|---|---|
| Static surface tension @25° C. (mN/m) | 29 | 29 | 29 | 32 | 29 | 29 | 72 | 22 |
| Viscosity @25° C. (mPa · s) | 1.4 | 1.4 | 1.5 | 3.0 | 1.0 | 1.0 | 1.0 | 7.7 |
| Removal rate (%) | 100 | 100 | 100 | 90 | 70 | 80 | 0 | 0 |
| Drying suppression rate (%) | 30 | 29 | 16 | 11 | 31 | 33 | 5 | 43 |

What is claimed is:

1. A cleaning unit for cleaning a nozzle surface of an inkjet printhead, comprising:
a flexible porous material; and
a cleaning liquid impregnated in the flexible porous material and having viscosity at 25° C. of 7 mPa·s or less and static surface tension at 25° C. of 40 mN/m or less, and containing from 10 mass % or more to 60 mass % or less of a water-soluble organic solvent, wherein a vapor pressure of the water-soluble organic solvent at 25° C. is lower than that of water.

2. The cleaning unit according to claim 1, wherein the vapor pressure of the water-soluble organic solvent at 25° C. is 2.5 kPa or less.

3. A cleaning method, comprising:
an immersion step of holding a nozzle surface of an inkjet head that is pushed into a flexible porous material of a cleaning unit; and
a wiping step of wiping the nozzle surface with a wiping member after the immersion step, wherein the cleaning unit including the flexible porous material and a cleaning liquid impregnated in the flexible porous material and having viscosity at 25° C. of 7 mPa·s or less and static surface tension at 25° C. of 40 mN/m or less, and containing from 10 mass % or more to 60 mass % or less of a water-soluble organic solvent, and wherein a vapor pressure of the water-soluble organic solvent at 25° C. is lower than that of water.

4. The cleaning method according to claim 3, wherein the wiping member is a blade.
